(19) United States
(12) Patent Application Publication
(10) Pub. No.: US 2016/0271903 A1
(43) Pub. Date: Sep. 22, 2016

(54) WARM KNITTED FABRIC WITH MOXA PAD

(71) Applicant: SU IK PARK, SEOUL (KR)

(72) Inventor: SU IK PARK, SEOUL (KR)

(21) Appl. No.: 14/660,264

(22) Filed: Mar. 17, 2015

(51) Int. Cl. B32B 5/26; B32B 7/08; B32B 5/02

(52) U.S. Cl. CPC B32B 5/26; B32B 5/026; B32B 5/022; B32B 7/08; B32B 2262/062; B32B 2307/304; B32B 2437/00

(57) ABSTRACT

A warm knitted fabric includes a fibrous cotton-shaped moxa particle pad, an upper knitted fabric layer and a lower knitted fabric layer. The upper knitted fabric layer is disposed on top of the fibrous cotton-shaped moxa particle pad. The lower knitted fabric layer disposed on underside of the fibrous cotton-shaped moxa particle pad and has the same size or design as the upper knitted fabric layer. The fibrous cotton-shaped moxa particle pad spreads out between the upper and lower knitted fabric layer to predetermined size and volume. The upper knitted fabric layer, the fibrous cotton-shaped moxa particle pad, and the lower knitted fabric layer are sewn to each other at predetermined sewing intervals.

### BACKGROUND OF THE INVENTION

1. Field of the Invention

The present invention relates to a warm knitted fabric with a moxa pad, and more particularly, to a warm knitted fabric with a moxa pad is configured wherein a fine fibrous cotton-shaped moxa particle pad is placed between an upper knitted fabric layer and a lower knitted fabric layer, and the fibrous moxa particle pad, the upper knitted fabric layer, and the lower knitted fabric layer are sewn to each other, so that the warm knitted fabric with the moxa pad is used for a separate inner fabric of clothing, inner wear and outer wear of clothing, stuffed toys, materials for daily products, and finished products.

2. Background of the Related Art

Moxa is a plant that has heat and is used as a medical material from old times. So as to apply moxa to a separate inner fabric of clothing, matured and dried moxa is pulverized by a pulverizer, and the sizes of fibrous moxa particles are adjusted, so that the pulverized fibrous fine moxa particles gather to form a cotton-like shape. However, the fine fibrous cotton-shaped moxa particles get entangled and banded to each other, and accordingly, they cannot be used in a shape of a cotton pad, thus making it hard to be used for the separate inner fabric of clothing.

So as to allow the fine fibrous cotton-shaped moxa particles to be used for the separate inner fabric of clothing, accordingly, the fine fibrous cotton-shaped moxa particles spread out to given size and volume between upper and lower knitted fabric layers, and they are sewn to each other at given intervals, thus preventing thee fine fibrous cotton-shaped moxa particles from being entangled and banded to each other. If a separate inner fabric of clothing is made of the warm knitted fabric with the moxa pad, it can be usefully used to warm up the belly of the body.

### SUMMARY OF THE INVENTION

Accordingly, the present invention has been made in view of the above-mentioned problems occurring in the prior art, and it is an object of the present invention to provide a warm knitted fabric with a moxa pad is configured wherein a fine fibrous cotton-shaped moxa particle pad is placed between an upper knitted fabric layer and a lower knitted fabric layer, and the fibrous moxa particle pad, the upper knitted fabric layer, and the lower knitted fabric layer are sewn to each other, so that the warm knitted fabric with the moxa pad is used for a separate inner fabric of clothing, inner wear and outer wear of clothing, stuffed toys, materials for daily products, and finished products.

To accomplish the above-mentioned object, according to the present invention, there is provided a warm knitted fabric including: a fine fibrous cotton-shaped moxa particle pad; an upper knitted fabric layer disposed on top of the fine fibrous cotton-shaped moxa particle pad; and a lower knitted fabric layer disposed on underside of the fine fibrous cotton-shaped moxa particle pad and having the same size or design as the upper knitted fabric layer, wherein the fine fibrous cotton-shaped moxa particle pad spreads out between the upper knitted fabric layer and the lower knitted fabric layer in such a manner as to have given size and volume, and the upper knitted fabric layer, the fine fibrous cotton-shaped moxa particle pad, and the lower knitted fabric layer are sewn to each other at appropriate sewing intervals in accordance with the purposes and uses thereof.

According to the present invention, preferably, after matured and dried moxa is pulverized with the adjustment of the sizes of the fibrous cotton of the moxa, the fine fibrous cotton-shaped moxa particles from which impurities except the cotton component of the moxa are removed gather and spread out to given size and volume between the upper knitted fabric layer and the lower knitted fabric layer by means of a manual, semi-automatic, or full automatic roller, and next, the upper knitted fabric layer, the fine fibrous cotton-shaped moxa particle pad, and the lower knitted fabric layer are sewn to each other to shapes of crosses at appropriate sewing intervals in the range of 1 mm to 5 cm by means of lock stitching, semi-automatic, or full automatic sewing manner in accordance with the purposes and uses of materials and products.

According to the present invention, preferably, the warm knitted fabrics with the moxa pad having the same sizes as each other are sewn to each other along the edges of a product cut with the design appropriate for the purposes of the product and then used as a finished product.

According to the present invention, preferably, the fine fibrous cotton-shaped moxa particle pad is placed between the upper knitted fabric layer and the lower knitted fabric layer having the same design as each other in such a manner as to have given size and volume appropriate for the purposes of products, and the upper knitted fabric layer, the fine fibrous cotton-shaped moxa particle pad, and the lower knitted fabric layer are sewn to each other at appropriate sewing intervals in accordance with the purposes and uses thereof and finished along the edges by means of sewing (lock stitching, overlock stitching, bias, lace attaching, and the like).

According to the present invention, preferably, in case of a small-sized product, portions of the edges of the upper knitted fabric layer and the lower knitted fabric layer having the same design as each other are first sewn to each other, and after the sewn portions are turned over to allow the fine fibrous cotton-shaped moxa particle pad to spread out between the upper knitted fabric layer and the lower knitted fabric layer, the other portions of the edges of the upper knitted fabric layer and the lower knitted fabric layer are folded and sewn to each other.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a to 1c are front and rear views showing a warm knitted fabric with a moxa pad according to the present invention, wherein FIG. 1a shows a lower knitted fabric layer, FIG. 1b shows a fine fibrous cotton-shaped moxa particle pad, and FIG. 1c shows an upper knitted fabric layer;

FIG. 2 is an exemplary view showing the warm knitted fabric with the moxa pad according to the present invention, wherein the lower knitted fabric layer, the fine fibrous cotton-shaped moxa particle pad, and the upper knitted fabric layer are sewn to each other; and

FIG. 3 is an exemplary view showing a finished product made using the warm knitted fabric with the moxa pad according to the present invention, wherein the warm knitted fabric as shown in FIG. 2 is cut to a shape of a circle and sewn with a bias tape along the outer peripheral edge thereof.

### DETAILED DESCRIPTION OF THE PREFERRED EMBODIMENTS

Hereinafter, an explanation on a warm knitted fabric with a moxa pad according to the present invention will be in detail given with reference to the attached drawing.

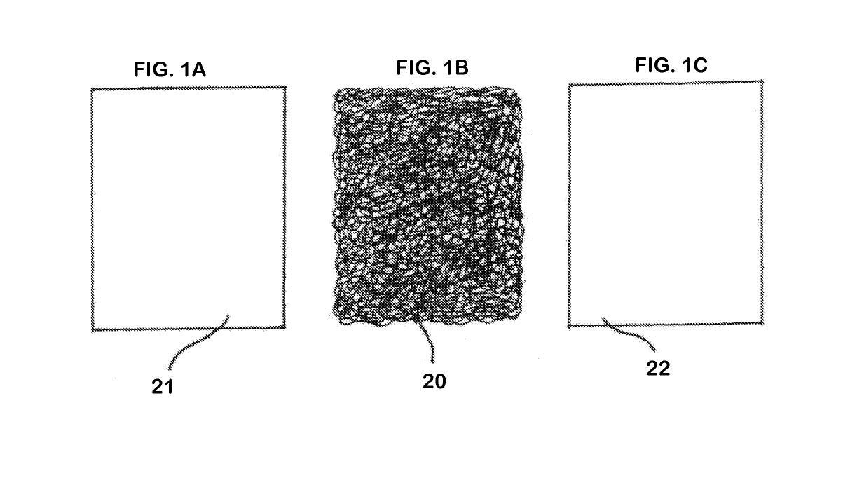

FIGS. 1a to 1c are front and rear views showing warm knitted fabric with a moxa pad according to the present invention, wherein FIG. 1a shows a lower knitted fabric layer, FIG. 1b shows a fine fibrous cotton-shaped moxa particle pad, and FIG. 1c shows an upper knitted fabric layer.

Referring to FIGS. 1a to 1c, FIG. 1a shows a lower knitted fabric layer 21, FIG. 1b shows a fine fibrous cotton-shaped moxa particle pad 20 having a volume of 3 cm or below and particle sizes of 3 mm or below, and FIG. 1c shows an upper knitted fabric layer 22.

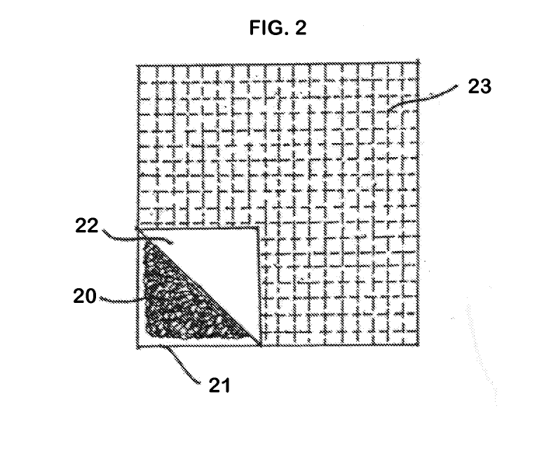

FIG. 2 is an exemplary view showing the warm knitted fabric with the moxa pad according to the present invention, wherein the lower knitted fabric layer, the fine fibrous cotton-shaped moxa particle pad, and the upper knitted fabric layer are sewn to each other.

Referring to FIG. 2, the lower knitted fabric layer 21 is first located, and the fine fibrous cotton-shaped moxa particle pad 20 having a volume of 3 cm or below and particle sizes of 3 mm or below spreads out on top of the lower knitted fabric layer 21 by means of a manual, semi-automatic, or full automatic roller. Next, the upper knitted fabric layer 22 is located on top of the fine fibrous cotton-shaped moxa particle pad 20, and they are sewn to each other in shapes of crosses at appropriate sewing intervals in the range of 5 cm or below in a manual, semi-automatic, or full automatic manner.

In case of a small-sized product, of course, the above-mentioned process is manually conducted, and more efficiently, they are sewn to each other through lock stitching.

As shown in FIG. 2, the fine fibrous cotton-shaped moxa particle pad 20 having a volume of 3 cm or below and particle sizes of 3 mm or below spreads out on top of the lower knitted fabric layer 21. For example, if the warm knitted fabric is used for a separate inner fabric for the wear warming up the body's belly, the fine fibrous cotton-shaped moxa particle pad 20 has a volume of 5 mm or less, preferably, a volume of 3 mm spreads out on top of the lower knitted fabric layer 21, and next, the upper knitted fabric layer 22 is located on top of the fine fibrous cotton-shaped moxa particle pad 20. After that, they are sewn to each other in shapes of crosses at appropriate sewing intervals of 3 mm in a manual, semi-automatic, or full automatic manner.

In the sewing process, the number of sewing needles of the sewing machine is one. So as to improve the productivity of the warm knitted fabric according to the present invention, however, two or more sewing needles may be mounted on the single sewing machine, and otherwise, a portion of an automatic system sewing the inner fabric of a blanket having artificial or natural cotton may be improved and manufactured.

Of course, in case of the separate inner fabric having a relatively small size for the wear warming up the body's belly, more advantageously, the fine fibrous cotton-shaped moxa particle pad 20 is made manually, and the upper knitted fabric layer 22, the fine fibrous cotton-shaped moxa particle pad 20, and the lower knitted fabric layer 21 are sewn to each other through lock stitching. So as to obtain high aesthetic effects, the sewing work is conducted in various designs like wave patterns. The volume of the product may be adjusted by portion in accordance with the purposes and uses of the product like hard winter products. For example, the volume of the top end portion of the separate inner fabric for the wear warming up the body's belly is small, and the volume of the separate inner fabric located on the lower portion of the belly is relatively large.

Of course, one of the upper knitted fabric layer 22 and the lower knitted fabric layer 21 is formed of a woven fabric and the other is formed of a knitted fabric in accordance with the purposes and uses of the warm knitted fabric according to the present invention.

Furthermore, a windproof functional fabric or artificial or natural leather is attached directly or indirectly to one side surface of the warm knitted fabric with the moxa pad according to the present invention, preferably, to the upper knitted fabric layer 22, so that the warm knitted fabric with the moxa pad according to the present invention can be made appropriately for the specific purposes of the product like hard winter products.

According to the present invention, the warm knitted fabric with the moxa pad is used for various products like the inner wear and outer wear of clothing, stuffed toys and daily products as well as for various materials of the products. In accordance with the purposes and uses of the warm knitted fabric according to the present invention, further, the lower knitted fabric layer 21, the upper knitted fabric layer 22, and the fine fibrous cotton-shaped moxa particle pad 20 are adjusted in their volume according to their portions, and their sewing sizes are adjustable. For example, the lower knitted fabric layer 21 and the upper knitted fabric layer 22 may be formed of thin gauze fabrics and otherwise, they may be formed of thick fabrics such as, organic, natural, natural dyed, artificial and functional fibers, and artificial and natural leather.

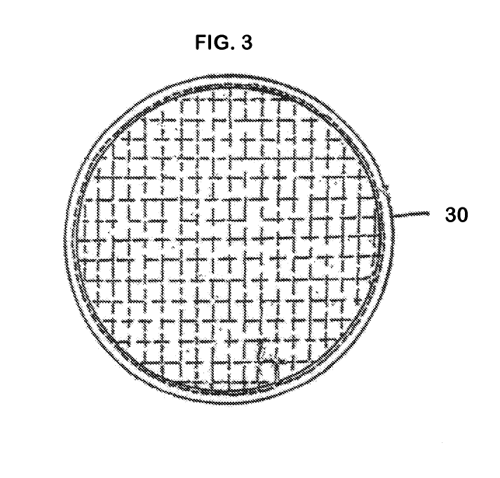

FIG. 3 is an exemplary view showing a finished product made using the warm knitted fabric with the moxa pad according to the present invention, wherein the warm knitted fabric as shown in FIG. 2 is cut to a shape of a circle and sewn with a bias tape along the outer peripheral edges thereof, thus being used as the finished product as well as the materials for products.

On the other hand, according to the present invention, the lower knitted fabric layer 21 and the upper knitted fabric layer 22 have the same size or design as each other. In accordance with the purposes and uses of the warm knitted fabric according to the present invention, however, if the lower knitted fabric layer 21 is made of a woven fabric, the upper knitted fabric layer 22 is made of a knitted fabric, and vice versa.

A fabric may be additionally attached to one side surface of the warm knitted fabric in accordance with the purposes and uses thereof, and especially, a windproof functional fabric or leather is attached directly or indirectly to the upper knitted fabric layer 22 when the warm knitted fabric is used for hard winter products.

In accordance with the purposes and uses of the warm knitted fabric according to the present invention, of course, the volume of the fine fibrous cotton-shaped moxa particle pad 20 becomes small or large over the entire portion or a portion thereof, and otherwise, the fine fibrous cotton-shaped moxa particle pad 20 may be mixed with a fibrous mugwort particle pad. Further, the fibrous mugwort particle pad may be used alone and sewn to the upper knitted fabric layer 22 and the lower knitted fabric layer 21.

Moreover, the fibrous moxa particle pad 20 or the fibrous mugwort particle pad may be mixed with a fibrous plant particle pad, and otherwise, the fibrous plant particle pad may be used alone and sewn to the upper knitted fabric layer 22 and the lower knitted fabric layer 21.

For example, a fibrous cotton-shaped particle pad of Angelica gigas as a flavorous medical plant is used alone or mixed with moxa, mugwort, and plant pads, and next, they are sewn to the upper knitted fabric layer 22 and the lower knitted fabric layer 21. In case where the warm knitted fabric of the present invention is used for a stuffed doll, for example, the outer surface of the stuffed doll is made of the warm knitted fabric with the moxa pad, and the interior of the stuffed doll is filled with the fibrous plant pad such as, moxa, mugwort, cotton, silk, Angelica gigas, wool, down, and the like which is used alone or mixed with each other and sewn or not sewn to each other, so that the small and large-sized stuffed dolls can be finished. The fibrous cotton-shaped plant particle pad includes all the portions from the roots of the plant to the fruits thereof, and otherwise, the leaves, flowers, fruits, stems and roots of the plant may be used alone or mixed with each other.

In this case, since the moxa and mugwort are cultivated in large quantities, harvested by a machine, matured and dried, and pulverized by a pulverizer, fibrous cotton-shaped plant particles may be a little mixed with the moxa and mugwort.

As described above, the warm knitted fabric with the moxa pad according to the present invention is configured wherein the fine fibrous cotton-shaped moxa particle pad is placed between the upper knitted fabric layer and the lower knitted fabric layer having the same size or design as each other, and then, they are sewn to each other. Further, if the warm knitted fabric is used for a separate inner fabric for the wear warming up the body's belly, it warms up the belly, and accordingly, it is used for inner wear and outer wear of clothing, stuffed toys, materials for daily products, and finished products, so that they can be advantageously and usefully used for the belly warming products and the daily products.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A warm knitted fabric comprising:
a fibrous cotton-shaped moxa particle pad;
an upper knitted fabric layer disposed on a top of the fibrous cotton-shaped moxa particle pad;
a lower knitted fabric layer disposed on an underside of the fibrous cotton-shaped moxa particle pad and having a same size or design as the upper knitted fabric layer; and
wherein the fibrous cotton-shaped moxa particle pad spreads out between the upper knitted fabric layer and the lower knitted fabric layer to predetermined size and volume, and the upper knitted fabric layer, the fibrous cotton-shaped moxa particle pad, and the lower knitted fabric layer are sewn to each other at predetermined sewing intervals.

2. The warm knitted fabric according to claim 1, wherein the fibrous cotton-shaped moxa particle pad is mixed with a fibrous cotton-shaped mugwort particle pad.

3. The warm knitted fabric according to claim 1, wherein the lower knitted fabric layer and the upper knitted fabric layer are formed of natural dyed fabrics.

4. The warm knitted fabric according to claim 1, wherein the fibrous cotton-shaped moxa particle pad is mixed with a fibrous cotton-shaped plant particle pad and sewn to the upper knitted fabric layer and the lower knitted fabric layer.

5. A warm knitted fabric comprising:
a fibrous cotton-shaped mugwort particle pad;
an upper knitted fabric layer disposed on a top of the fibrous cotton-shaped mugwort particle pad;
a lower knitted fabric layer disposed on an underside of the fibrous cotton-shaped mugwort particle pad and having a same size or design as the upper knitted fabric layer; and
wherein the fibrous cotton-shaped mugwort particle pad spreads out between the upper knitted fabric layer and the lower knitted fabric layer to predetermined size and volume, and the upper knitted fabric layer, the fibrous cotton-shaped mugwort particle pad, and the lower knitted fabric layer are sewn to each other at predetermined sewing intervals.

6. The warm knitted fabric according to claim 5, wherein the fibrous cotton-shaped mugwort particle pad is mixed with a fibrous cotton-shaped plant particle pad and sewn to the upper knitted fabric layer and the lower knitted fabric layer.
